(19) United States
(12) Patent Application Publication
(10) Pub. No.: US 2024/0391362 A1
(43) Pub. Date: Nov. 28, 2024

(54) Motor Vehicle Seat for a Motor Vehicle

(71) Applicant: Bayerische Motoren Werke Aktiengesellschaft, Muenchen (DE)

(72) Inventor: Michael LENG, Geltendorf (DE)

(21) Appl. No.: 18/694,089

(22) PCT Filed: Oct. 11, 2022
(86) PCT No.: PCT/EP2022/078223

§ 371 Date: Mar. 21, 2024

(30) Foreign Application Priority Data
Oct. 19, 2021 (DE) 10 2021 127 103.7

(51) Int. Cl. B60N 2/12

(52) U.S. Cl. CPC B60N 2/12

(57) ABSTRACT

A motor vehicle seat has a slotted guide and a seat structure that has a seat element and a backrest. The seat structure is adjustable from a use position, in which the seat element extends approximately horizontally, via an intermediate position to an entry position, in which the seat element is inclined with respect to the horizontal. By use of the slotted guide, the seat structure is guidable such that the seat structure is translatable from the use position as far as the intermediate position and is rotatable from the intermediate position as far as the entry position.

### BACKGROUND AND SUMMARY

The present invention relates to a motor vehicle seat for a motor vehicle having a seat structure with a seat element and a backrest, wherein the seat structure is adjustable from a use position, in which the seat element extends approximately horizontally, via an intermediate position into an entry position, in which the seat element is inclined with respect to the horizontal.

So that, in the case of a three-door motor vehicle, occupants can get to a second row of seats or, in the case of a five-door motor vehicle, occupants can get to a third row of seats, a motor vehicle seat generally has to be adjustable from a use position, in which an occupant can sit on the motor vehicle seat, into an entry position, in which a space is opened up between the motor vehicle seat and a rear edge of a door opening of the motor vehicle, permitting access to the second and/or third row of seats.

A motor vehicle seat which permits such an adjustment movement is known, for example, from DE 10 2004 047 250 A1 and comprises a seat structure and a device for adjustment of the motor vehicle seat. The device for adjustment of the motor vehicle seat has a multiplicity of four-bar linkages which are connected to the seat structure for adjustment of same.

In the case of the motor vehicle seat described in DE 10 2004 047 250 A1, the adjustment of the seat structure between the use position and the entry position thus requires the device for adjusting the motor vehicle seat, comprising the multiplicity of four-bar linkages. Consequently, the device for adjusting the motor vehicle seat is structurally complicated.

It is an object of the present invention to provide a motor vehicle seat which is adjustable between a use position and an entry position by means of a simple construction.

This object is achieved by the motor vehicle seat having the features of the independent claims.

According to the invention, a motor vehicle seat for a motor vehicle is therefore provided which comprises a seat structure with a seat element and a backrest, and a slotted guide. The seat structure is adjustable from a use position, in which the seat element extends approximately horizontally and is capable of receiving an occupant, via an intermediate position into an entry position, and vice versa. In the intermediate position, the seat element is movable forward from the use position in the longitudinal direction of the motor vehicle seat. In the entry position, the seat element is inclined with respect to the horizontal, in particular forward, in the longitudinal direction of the motor vehicle seat about an axis of rotation extending in the transverse direction of the motor vehicle seat. This opens up a space behind the motor vehicle seat, in particular between the motor vehicle seat and a rear edge of a door opening. The occupant can therefore get to a space located behind the motor vehicle seat. For example, a further motor vehicle seat of a rear row of seats is arranged in the space located behind the motor vehicle seat. By means of the slotted guide, the seat structure can be guided during an adjustment of the seat structure from the use position as far as the intermediate position in such a manner that the seat structure moves translationally. From the intermediate position as far as the entry position, the seat structure can be guided by means of the slotted guide in such a manner that the seat structure moves rotationally.

The essence of the invention is therefore to provide the motor vehicle seat with a slotted guide which is configured in such a manner that, in a region from the use position as far as the intermediate position (excluding the intermediate position), the slotted guide permits a purely translational movement of the seat structure and, in a region from the intermediate position as far as the entry position, permits a purely rotational movement of the seat structure. The rotational movement can therefore be enabled by means of the translational movement. An adjustment of the seat structure between the use position and the entry position is therefore made possible in a structurally simple manner.

In a preferred embodiment of the motor vehicle seat according to the invention, the slotted guide comprises a first guide slot and a first guide pin. The first guide slot extends in the longitudinal direction of the motor vehicle seat. The first guide pin extends in the transverse direction of the motor vehicle seat. The first guide pin is guided displaceably in the first guide slot in the longitudinal direction of the motor vehicle seat.

The first guide pin is connected rigidly, for example, to the seat structure, in particular to the seat element, and extends outward in the transverse direction of the motor vehicle seat, i.e. away from the seat element. The first guide slot is, for example, fixed on the bodywork. In particular, the first guide slot is, for example, connected rigidly to a floor of the motor vehicle and/or to the guide rail of the motor vehicle seat.

Alternatively, the first guide pin can be arranged in a manner fixed on the bodywork. In particular, the first guide pin can be connected rigidly to the floor of the motor vehicle and/or to the guide rail of the motor vehicle seat. The first guide pin can extend inward in the transverse direction of the motor vehicle seat, i.e. in the direction of the seat structure, in particular in the direction of the seat element. The first guide slot can be formed in the seat structure, in particular in the seat element.

In an exemplary embodiment of the motor vehicle seat according to the invention, the slotted guide comprises a second guide slot and a second guide pin. The second guide slot comprises a straight portion extending in the longitudinal direction of the motor vehicle seat and a curved, in particular circular-arc-shaped circular arc portion. The circular arc portion is arranged adjacent to the straight portion in front of same in the longitudinal direction of the motor vehicle seat. The straight portion therefore merges into the circular arc portion. The second guide pin is guided displaceably in the second guide slot. In particular, the second guide pin is guided displaceably in the straight portion of the second guide slot in the longitudinal direction of the motor vehicle seat. In the circular arc portion of the second guide slot, the second guide pin is guided displaceably in particular in the longitudinal direction of the motor vehicle seat and in the vertical direction of the motor vehicle seat.

The second guide pin is connected, for example, rigidly to the seat structure, in particular to the seat element, and extends outward in the transverse direction of the motor vehicle seat, i.e. away from the seat element. The second guide slot is, for example, fixed on the bodywork. In particular, the second guide slot is connected rigidly, for example, to a floor of the motor vehicle and/or to the guide rail of the motor vehicle seat.

Alternatively, the second guide pin can be arranged fixed on the bodywork. In particular, the second guide pin can be connected rigidly to the floor of the motor vehicle and/or to the guide rail of the motor vehicle seat. The second guide pin can extend inward in the transverse direction of the motor vehicle seat, i.e. in the direction of the seat structure, in particular in the direction of the seat element. The first guide slot can be formed in the seat structure, in particular in the seat element. In this connection, the seat structure is displaceable forward in the longitudinal direction of the motor vehicle seat from the use position firstly in a translational manner because of the rectilinear configuration of the straight portion of the second guide slot. As soon as the second guide pin reaches the front end of the straight portion and passes into the circular arc portion, the seat structure is rotated about an axis of rotation extending in the transverse direction of the motor vehicle seat.

The circular arc portion of the second guide slot can extend from the straight portion upward in the vertical direction of the motor vehicle seat and forward in the longitudinal direction of the motor vehicle seat.

The first guide slot or the first guide pin is arranged, for example, in a side element of a motor vehicle seat structure fitting.

The second guide slot or the second guide pin is arranged, for example, in the side element of the motor vehicle seat structure fitting.

The side element can be arranged laterally of the seat structure, in particular laterally of the seat element, in the transverse direction of the motor vehicle seat.

The side element can extend in the longitudinal direction of the motor vehicle seat.

The first guide pin or the first guide slot is fixed or formed, for example, laterally on the seat structure, in particular laterally on the seat element.

The second guide pin or the second guide slot is fixed or arranged, for example, laterally on the seat structure, in particular laterally on the seat element.

The first guide slot can be arranged in front of the second guide slot in the longitudinal direction of the motor vehicle seat.

In a preferred embodiment of the motor vehicle seat according to the invention, the first guide pin defines an axis of rotation which extends in the transverse direction of the motor vehicle seat and about which the seat structure is pivotable when the second guide pin is arranged in the circular arc portion of the second guide slot.

The first guide pin can lie here against a front end of the first guide slot in the longitudinal direction of the motor vehicle seat.

The first guide pin can therefore form a circle center point of the circular arc portion of the second guide slot when the second guide pin is arranged in the circular arc portion of the second guide slot and/or when the first guide pin lies against a front end of the first guide slot in the longitudinal direction of the motor vehicle seat.

In a preferred embodiment, the motor vehicle seat according to the invention comprises a locking arrangement for securing the seat structure in the use position, in particular against rotation. The locking arrangement comprises a locking bolt and a cutout. In the cutout, the locking bolt is arranged in the use position. The cutout is open on one side in the longitudinal direction of the motor vehicle seat such that, when the seat structure is adjusted from the use position into the entry position, the locking bolt can be removed from the cutout. This permits rotation of the motor vehicle seat such that the motor vehicle seat is pivotable into the use position.

The locking bolt can be arranged laterally on the seat structure, in particular on the seat element, and extend outward, i.e. away from the seat structure in the transverse direction of the motor vehicle seat. The cutout can be formed in the side element and be open forward in the longitudinal direction of the motor vehicle seat.

Therefore, the locking bolt can be arranged in the cutout in the use position and outside the cutout, in particular in front of the cutout in the longitudinal direction of the motor vehicle seat, in the entry position.

Alternatively, the locking bolt can be arranged laterally on the side element and can extend inward in the transverse direction of the motor vehicle seat, i.e. in the direction of the seat structure. The cutout can be formed on the seat structure, in particular on the seat element, and can be open rearward in the longitudinal direction of the motor vehicle seat.

Consequently, the locking bolt can be arranged in the use position, for example in the cutout, while it is arranged outside the cutout in the entry position, in particular is arranged behind the cutout in the longitudinal direction of the motor vehicle seat.

The cutout can be U-shaped. In particular, the cutout can have the shape of a horizontal U.

In an exemplary embodiment of the motor vehicle seat according to the invention, the cutout is shorter in the longitudinal direction of the motor vehicle seat than the first guide slot.

In a preferred embodiment of the motor vehicle seat according to the invention, the cutout is shorter in the longitudinal direction of the motor vehicle seat than the straight portion of the second guide slot.

The locking arrangement can comprise a securing element which secures the seat structure in the use position against adjustment forward in the longitudinal direction of the motor vehicle seat.

The securing element prevents, for example, displacement of the locking bolt relative to the cutout in the longitudinal direction of the motor vehicle seat.

The securing element is adjustable, for example, between a securing position and a release position. In the securing position, the locking bolt is secured in the cutout, in particular when displaced in the longitudinal direction of the motor vehicle seat. In the release position, the locking bolt can be removed from the cutout or introduced into the cutout.

The securing element can close the opening of the cutout in the securing position.

The seat structure can be adjustable manually between the use position and the entry position.

In an exemplary embodiment, the motor vehicle seat according to the invention comprises a drive unit. By means of the drive unit, the seat structure is adjustable in an automated manner between the use position and the entry position.

The drive unit has, for example, a drive bolt which extends in the transverse direction of the motor vehicle seat and is fixed rotatably on the seat structure. The drive bolt is rotatable by means of a motor.

The drive bolt can rest on the upper side of the side element in such a manner that, by rotation of the drive bolt, the seat structure is adjustable between the use position and the entry position, i.e. the drive bolt transmits its rotational movement to the seat structure, as a result of which the seat structure undergoes an adjustment movement.

Alternatively, the first side element can comprise a drive cutout in which the drive bolt is arranged in such a manner that, by rotation of the drive bolt, the seat structure is adjustable between the use position and the entry position.

The drive bolt can comprise a gearwheel which meshes with a toothing of the upper side of the side element or with a toothing of a wall defining the second cutout.

The upper side of the side element, in particular in the region in which the drive bolt is displaceable, can comprise a straight portion and a curved portion adjacent to the straight portion at the front in the longitudinal direction of the motor vehicle seat.

The curved portion can extend from the straight portion of the upper side of the side element forward in the longitudinal direction of the motor vehicle seat and downward in the vertical direction of the motor vehicle seat.

Therefore, contact between the drive bolt and the upper side of the side element can be ensured both during the translational movement and during the rotational movement of the seat structure.

The second cutout can comprise a straight portion and a curved portion which is adjacent to the straight portion at the front in the longitudinal direction of the motor vehicle seat.

The curved portion can extend from the straight portion of the second cutout forward in the longitudinal direction of the motor vehicle seat and downward in the vertical direction of the motor vehicle seat.

Consequently, contact between the drive bolt and the wall defining the second cutout is ensured during the translational movement and during the rotational movement of the seat structure.

The curved portion can have the shape of a circular arc.

The circle center point of the circular arc is, for example, the axis of rotation about which the seat structure is pivotable, i.e. the first guide pin, when the second guide pin is arranged in the circular arc portion of the second guide slot.

The seat structure fitting, in particular the side element, can be fixable to a seat rail, which is fixed to a floor of the motor vehicle, and/or to the floor of the motor vehicle.

In a preferred embodiment, the motor vehicle seat according to the invention comprises a further slotted guide described previously. The further slotted guide is arranged on a side of the seat element opposite the slotted guide in the transverse direction of the motor vehicle seat.

The further slotted guide can be formed mirror-symmetrically to the slotted guide with respect to a longitudinal center plane of the motor vehicle seat.

In an exemplary embodiment, the motor vehicle seat according to the invention comprises a further locking arrangement described previously. The further locking arrangement is arranged on a side of the seat element opposite the locking arrangement in the transverse direction of the motor vehicle seat.

The further locking arrangement can be formed mirror-symmetrically to the locking arrangement with respect to a longitudinal center plane of the motor vehicle seat.

The motor vehicle seat can comprise a further drive unit described previously. The further drive unit can be arranged on a side of the seat element opposite the drive unit in the transverse direction of the motor vehicle seat.

The further drive unit can be formed mirror-symmetrically to the drive unit with respect to a longitudinal center plane of the motor vehicle seat.

The invention is explained in more detail below with reference to an exemplary embodiment illustrated in the drawings.

### BRIEF DESCRIPTION OF THE DRAWINGS

FIG. 1 is a side view of a motor vehicle seat according to an embodiment of the invention in a use position, comprising a side element;

FIG. 2 is a side view of the motor vehicle seat from FIG. 1 in an intermediate position;

FIG. 3 is a side view of the motor vehicle seat from FIG. 1 in an entry position; and

FIG. 4 is a detailed view of an alternative side element.

### DETAILED DESCRIPTION OF THE DRAWINGS

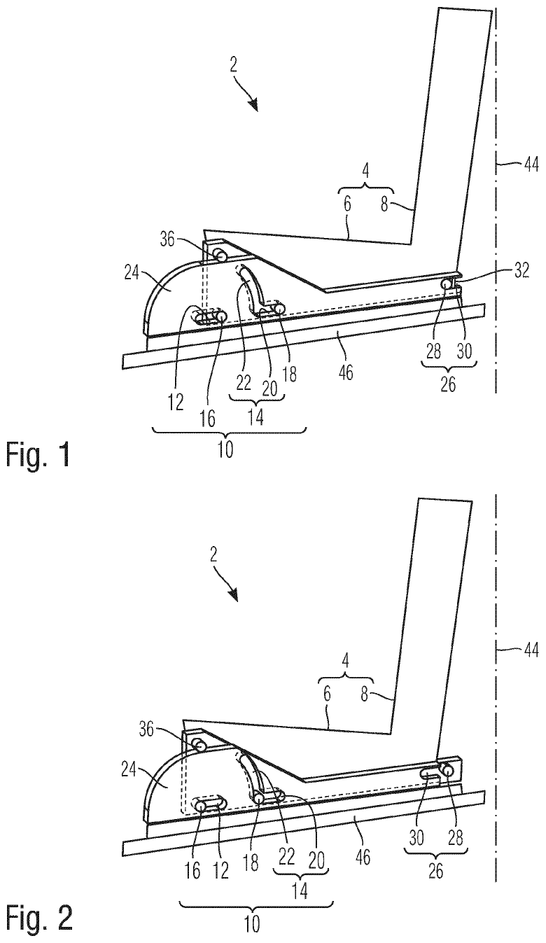

FIGS. 1 to 3 illustrate a motor vehicle seat 2 according to an embodiment of the invention. The motor vehicle seat 2 comprises a seat structure 4 with a seat element 6 and a backrest 8, a motor vehicle seat structure fitting, a slotted guide 10, a locking arrangement 26 and a drive arrangement.

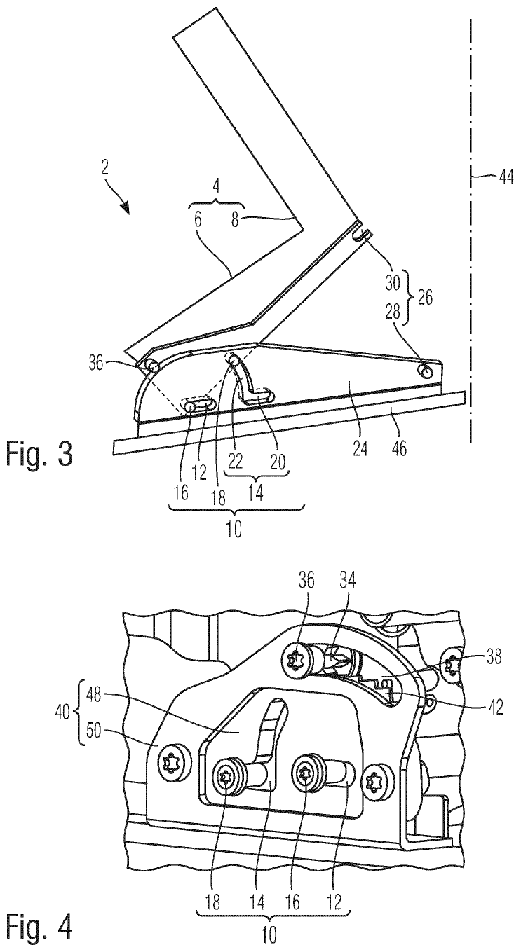

The seat structure 4 is adjustable by means of the slotted guide 10 and the drive arrangement between a use position illustrated in FIG. 1 via an intermediate position shown in FIG. 2 into an entry position shown in FIG. 3.

The slotted guide 10 serves here for guiding the adjustment movement. The adjustment movement can be carried out in an automated manner by means of the drive arrangement.

In the use position, the seat element 6 runs substantially horizontally, and therefore an occupant can sit on the seat structure 4. In the intermediate position, the seat structure 4 is displaced from the use position forward translationally in the longitudinal direction of the motor vehicle seat. If the seat structure 4, in addition to the translational displacement forward in the longitudinal direction of the motor vehicle seat, i.e. in addition to the displacement of the seat structure 4 into the intermediate position, is pivoted forward and upward about an axis of rotation extending in the transverse direction of the motor vehicle seat, the seat structure 4 is in the entry position. In the entry position, space permitting access to a region located behind the motor vehicle seat 2 is opened up between the seat structure 4 and a rear edge of a door opening 44.

In order to permit an adjustment movement of this type, the slotted guide 10 comprises a first guide slot 12, a second guide slot 14, a first guide pin 16 and a second guide pin 18. The first guide slot 12 and the second guide slot 14 are each in the form of a recess in a side element 24 of the motor vehicle seat structure fitting. The side element 24 is located laterally next to the seat structure 4 in the transverse direction of the motor vehicle seat, in particular to the seat element 6, and is fixed to a seat longitudinal adjustment structure 46 of the motor vehicle seat 2, which seat longitudinal adjustment structure in turn is fixed to a motor vehicle floor.

It is also contemplated for the motor vehicle seat structure fitting to comprise a further side element which is arranged in the transverse direction of the motor vehicle seat on the side of the seat structure 4 opposite the first side element 24 and to comprise a further first guide slot and a further second guide slot, in which a further first guide pin and a further second guide pin are respectively arranged.

The first guide slot 12 is a recess extending in the longitudinal direction of the motor vehicle seat. The first guide slot 12 is arranged in front of the second guide slot 14 in the longitudinal direction of the motor vehicle seat.

The second guide slot 14 comprises a straight portion 20 and a curved, in particular circular-arc-shaped circular arc portion 22. The straight portion 20 borders the circular arc portion 22 at the rear in the longitudinal direction of the motor vehicle seat. In particular, the circular arc portion 22 merges into the straight portion 20. The circular arc portion 22 extends from the straight portion 20 in the shape of a circular arc upward in the vertical direction of the motor vehicle seat and forward in the longitudinal direction of the motor vehicle seat.

A first guide pin 16 is guided displaceably in the first guide slot 12. The second guide slot 14 supports a second guide pin 18 displaceably. The first guide pin 16 and the second guide pin 18 are each fixed to the seat structure 4 and extend in the direction of the side element 24 in the transverse direction of the motor vehicle seat.

The first guide slot 12 and the straight portion 20 of the second guide slot 14 are identical in length in the longitudinal direction of the motor vehicle seat. Therefore, the first guide pin 16, when the second guide pin 18 lies at the rear in the longitudinal direction of the motor vehicle seat against a wall defining the straight portion 20 of the second guide slot 14, lies at the rear in the longitudinal direction of the motor vehicle seat against a wall defining the first guide slot 12. If, by contrast, the second guide pin 18 lies at the front in the longitudinal direction of the motor vehicle seat against the wall defining the straight portion 20, the first guide pin 16 likewise lies at the front in the longitudinal direction of the motor vehicle seat against the wall defining the first guide slot 12.

In order to displace the first guide pin 16 in the first guide slot 12 and the second guide pin 14 in the second guide slot 18, the drive arrangement comprises a drive bolt 36. The drive bolt 36 is fixed to the seat structure 4 so as to be rotatable about an axis of rotation extending in the transverse direction of the motor vehicle seat. A toothing (not illustrated) of the drive bolt 36 meshes with a toothing (not illustrated) which is formed on the upper side of the side element 24. Therefore, when the drive bolt 36 is rotated by means of a motor, the seat structure is moved relative to the side element 24 and consequently relative to the motor vehicle floor.

When the seat structure 4 is displaced from the use position in the longitudinal direction of the motor vehicle seat, the first guide pin 16 and the second guide pin 18 butt against the wall delimiting the first guide slot 12 and the straight portion 20 of the second guide slot 14 at the front in the longitudinal direction of the motor vehicle seat. This position is referred to as the intermediate position.

If the drive unit displaces the seat structure 4 further forward in the longitudinal direction of the motor vehicle seat from the intermediate position, the seat structure 4 is pivoted about the axis of rotation extending in the transverse direction of the motor vehicle seat because of the circular arc portion 22 of the second guide slot 14 and the second guide pin 18. The axis of rotation is defined here by the first guide pin 16, i.e., the axis of rotation extends through the center point of the first guide pin 16.

So that it is ensured that the toothing of the drive bolt 36 continuously meshes with the toothing formed on the upper side of the side element 24, the upper side of the side element 24 comprises a straight portion and a circular-arc-shaped portion. The circular-arc-shaped portion is adjacent at the front in the longitudinal direction of the motor vehicle seat to the straight portion in such a manner that the drive bolt 36 rests on the straight portion of the side element 24 when the second guide pin 18 is in the straight portion 20 of the second guide slot 14, and the drive bolt 36 rests on the circular-arc-shaped portion of the side element 24 when the second guide pin 18 is arranged in the circular arc portion 20 of the second guide slot 14. The circular arc center point of the circular-arc-shaped portion of the side element 24 lies in the center point of the first guide pin 16.

In order to reduce a force acting in particular forward and upward on the first guide pin 16 and on the second guide pin 18 in the use position, the motor vehicle seat 2 comprises a locking arrangement 26. The locking arrangement 26 has a cutout 30 and a locking bolt 28. So that the locking bolt 28 is not inadvertently removed from the cutout, the locking arrangement 26 comprises a securing element 32.

The cutout 30 is formed at a rear end of the seat structure 4, in particular of the seat element 6, in the longitudinal direction of the motor vehicle seat. The locking bolt 28 is fixed to a side element 24 and extends inward in the transverse direction of the motor vehicle seat, i.e. in the direction of the seat structure 4.

In the use position of the seat structure 4, the locking bolt 28 is arranged in the cutout 30 in such a manner that it lies at the front in the longitudinal direction of the motor vehicle seat and at the top and bottom in the vertical direction of the motor vehicle seat against a wall defining the cutout 30. The securing element 32 is arranged behind the locking bolt 28 in the longitudinal direction of the motor vehicle seat in the use position.

If the seat structure 4 is intended to be adjusted from the use position in the direction of the entry position, the securing element 32 behind the locking bolt 28 is removed. The cutout 30 is open at the rear in the longitudinal direction of the vehicle seat and is shorter than the straight portion 20 of the second guide pin 18. In particular, the cutout 30 has the shape of a horizontal U. By displacement of the seat structure 4 forward in the longitudinal direction of the motor vehicle seat, the locking bolt 28 is therefore removed from the cutout 30, at the latest when the intermediate position is reached.

FIG. 4 illustrates an alternative side element 40 which is usable instead of the side element 24 shown in FIGS. 1 to 3. The alternative side element 40 substantially corresponds to the side element 24 of the motor vehicle seat 2 illustrated in FIGS. 1 to 3. Consequently, only the differentiating features will be explained below. For all further features, the above explanations relating to the side element 24 apply correspondingly.

While the side element 24 illustrated in FIGS. 1 to 3 is formed in one part, the alternative side element 40 comprises a first side part element 48 and a second side part element 50 screwed to the first side part element 48.

In the first side part element 48, the first guide slot 12 and the second guide slot 14 are designed as in the side element 24.

The second side part element 50 comprises a drive cutout 38 in which the drive bolt 36 is guided. A wall defining the drive cutout 38 comprises a toothing with which the toothing of the drive bolt 36 meshes.

In the case of the side element 40 shown in FIG. 4, the drive bolt 38 is therefore not guided on the upper side of the side element 40, as in the case of the side element 24 illustrated in FIGS. 1 to 3, but rather in the drive cutout 38.

The drive cutout 38 comprises a straight portion and a circular-arc-shaped portion which is adjacent at the front in the longitudinal direction of the motor vehicle seat to the straight portion and extends from the straight portion forward in the longitudinal direction of the motor vehicle seat and downward in the vertical direction of the motor vehicle seat. The center point of the first guide pin 16 forms the circle center point of the circular-arc-shaped portion when the seat structure 4 is arranged in the intermediate position, in the entry position or in a position between the intermediate position and the entry position.

It is also contemplated for the side element 40 which is illustrated in FIG. 4 to be formed in one part.

### LIST OF REFERENCE SIGNS

2 motor vehicle seat
4 seat structure
6 seat element
8 backrest
10 slotted guide
12 first guide slot
14 second guide slot
16 first guide pin
18 second guide pin
20 straight portion
22 circular arc portion
24 side element
26 locking arrangement
28 locking bolt
30 cutout
32 securing element
34 toothing
36 drive bolt
38 drive cutout
40 alternative side element
42 toothing
44 rear edge of a door opening
46 seat longitudinal adjustment structure
48 first side part element
50 second side part element

1.-11. (canceled)

12. A motor vehicle seat for a motor vehicle, comprising:
a seat structure with a seat element and a backrest, wherein the seat structure is adjustable from a use position, in which the seat element extends approximately horizontally, via an intermediate position into an entry position, in which the seat element is inclined with respect to the horizontal; and
a slotted guide, by which the seat structure is guided such that the seat structure is movable translationally from the use position, as far as the intermediate position, and is movable rotationally from the intermediate position as far as the entry position.

13. The motor vehicle seat according to claim 12, wherein
the slotted guide comprises a first guide slot, which extends in a longitudinal direction of the motor vehicle seat, and a first guide pin which extends in a transverse direction of the motor vehicle seat and is guided displaceably in the first guide slot, and
the first guide slot or the first guide pin is connected rigidly to the seat structure and the first guide pin or the first guide slot is arrangeable in a manner fixed on bodywork of the vehicle.

14. The motor vehicle seat according to claim 13, wherein
the slotted guide comprises a second guide slot and a second guide pin,
the second guide slot comprises a straight portion extending in the longitudinal direction of the motor vehicle seat and a circular arc portion which is adjacent to the straight portion at a front in the longitudinal direction of the motor vehicle seat, and
the second guide pin extends in the transverse direction of the motor vehicle seat and is guided displaceably in the second guide slot.

15. The motor vehicle seat according to claim 14, wherein
the first guide pin defines an axis of rotation about which the seat structure is pivotable when the second guide pin is arranged in the circular arc portion of the second guide slot.

16. The motor vehicle seat according to claim 14, wherein
the first guide slot and the second guide slot are formed in a side element which is arranged laterally next to the seat structure in the transverse direction of the motor vehicle seat.

17. The motor vehicle seat according to claim 12, wherein
the slotted guide comprises a second guide slot and a second guide pin,
the second guide slot comprises a straight portion extending in the longitudinal direction of the motor vehicle seat and a circular arc portion which is adjacent to the straight portion at a front in the longitudinal direction of the motor vehicle seat, and
the second guide pin extends in the transverse direction of the motor vehicle seat and is guided displaceably in the second guide slot.

18. The motor vehicle seat according to claim 12, further comprising:
a locking arrangement comprising a locking bolt and a cutout in which the locking bolt is arranged in the use position, wherein
the cutout is open on one side in the longitudinal direction of the motor vehicle seat such that, when the seat structure is adjusted from the use position into the entry position, the locking bolt is removable from the cutout.

19. The motor vehicle seat according to claim 16, further comprising:
a locking arrangement comprising a locking bolt and a cutout in which the locking bolt is arranged in the use position, wherein
the cutout is open on one side in the longitudinal direction of the motor vehicle seat such that, when the seat structure is adjusted from the use position into the entry position, the locking bolt is removable from the cutout.

20. The motor vehicle seat according to claim 19, wherein
the locking bolt is arranged laterally on the seat structure and extends in the transverse direction of the motor vehicle seat, and the cutout is formed on the side element and is open forward in the longitudinal direction of the motor vehicle seat, or
the locking bolt is arranged laterally on the side element and extends in the transverse direction of the motor vehicle seat and the cutout is formed on the seat structure and is open rearward in the longitudinal direction of the motor vehicle seat.

21. The motor vehicle seat according to claim 20, wherein
the cutout is shorter in the longitudinal direction of the motor vehicle seat than the first guide slot and/or than the straight portion of the second guide slot.

22. The motor vehicle seat according to claim 18, wherein
the locking arrangement comprises a securing element which secures the seat structure in the use position against adjustment forward in the longitudinal direction of the motor vehicle seat.

23. The motor vehicle seat according to claim 16, further comprising:
a drive unit comprising a drive bolt which extends in the transverse direction of the motor vehicle seat and is fixed rotatably on the seat structure, is rotatable by a motor and rests on an upper side of the side element, or the first side element comprises a drive cutout in which the drive bolt is arranged, such that, by rotation of the drive bolt, the seat structure is adjustable between the use position and the entry position.

24. The motor vehicle seat according to claim 12, further comprising:
a further slotted guide which is arranged on a side of the seat structure opposite the slotted guide in the transverse direction of the motor vehicle seat and is formed mirror-symmetrically to the slotted guide with respect to a longitudinal center plane of the motor vehicle seat, and/or
a further locking arrangement which is arranged on a side of the seat structure opposite the locking arrangement in the transverse direction of the motor vehicle seat and is formed mirror-symmetrically to the locking arrangement with respect to a longitudinal center plane of the motor vehicle seat.
